(19) United States
(12) Patent Application Publication
(10) Pub. No.: US 2017/0302457 A1
(43) Pub. Date: Oct. 19, 2017

(54) SIGNATURE APPARATUS, SIGNATURE METHOD, VERIFICATION APPARATUS, VERIFICATION METHOD, AND NON-TRANSITORY COMPUTER-READABLE STORAGE MEDIUM

(71) Applicant: CANON KABUSHIKI KAISHA, Tokyo (JP)

(72) Inventor: Yasuhiro Nakamoto, Kawasaki-shi (JP)

(21) Appl. No.: 15/481,999

(22) Filed: Apr. 7, 2017

(30) Foreign Application Priority Data
Apr. 14, 2016 (JP) 2016-081462

(51) Int. Cl. H04L 9/32; H04L 9/30; H04L 9/14; G06F 21/36

(52) U.S. Cl. CPC H04L 9/3263; H04L 9/3247; G06F 21/36; H04L 9/14; H04L 9/30

(57) ABSTRACT

A first signature key that is a signature key assigned to a user is used to generate, as first signature data, signature data of an input image. A second signature key that is a signature key assigned to the signature apparatus is used to generate, as second signature data, signature data of data that includes the input image and the first signature data. Coupled data that includes the first signature data, the second signature data, and the input image is outputted.

### BACKGROUND OF THE INVENTION

### Field of the Invention

The present invention relates to techniques for signatures and the verification of signatures.

### Description of the Related Art

Image data captured by a digital camera or the like has come to be used in evidence photographs for the police or construction work. Accordingly, a technique that can certify that image data has not been altered after capturing has been proposed, and an image data falsification detection system in accordance with digital signature data that uses cryptography has been disclosed.

For example, a system disclosed in U.S. Pat. No. 5,499,294 is configured by a digital camera for generating image data and an image verification apparatus for verifying that the image data has not been falsified. The digital camera generates digital signature data by executing a predetermined calculation based on a private key unique to an image generation apparatus and image data captured and digitized by the digital camera. The digital signature data and the image data are set as the output of the digital camera. The image verification apparatus performs a verification by comparing data of a result of performing the predetermined calculation on the image data, and data obtained by performing an inverse operation of the calculation at a time of the aforementioned generation of the digital signature data.

In addition, in a technique disclosed in Japanese Patent Laid-Open No. 2005-197901, a photographer and a camera body ID are linked on a management server in advance. By linking the camera body ID as image capturing information to an image at a time of signing, an association between the image and the photographer can be made by confirming the signature.

However, in accordance with the conventional techniques, there is a one-to-one correspondence between a photographer and a camera body, and, for example, these conventional techniques do not handle a case in which there are a plurality of photographers that use the camera body.

### SUMMARY OF THE INVENTION

The present invention was conceived in view of these kinds of problems, and provides a technique for enabling user authentication of an apparatus, even if a user of the apparatus changes.

According to the first aspect of the present invention, there is provided a signature apparatus, comprising: a first generation unit configured to use a first signature key that is a signature key assigned to a user to generate, as first signature data, signature data of an input image; a second generation unit configured to use a second signature key that is a signature key assigned to the signature apparatus to generate, as second signature data, signature data of data that includes the input image and the first signature data; and an output unit configured to output coupled data that includes the first signature data, the second signature data, and the input image.

According to the second aspect of the present invention, there is provided a verification apparatus, comprising: an acquisition unit configured to acquire first signature data of an input image generated by using a signature key assigned to a user, and second signature data of data that includes the input image and the first signature data and is generated by using a signature key assigned to a signature apparatus; and a determination unit configured to determine success or failure of authentication of a user of the signature apparatus in accordance with a signature source corresponding to the second signature data and a signature source corresponding to the first signature data.

According to the third aspect of the present invention, there is provided a signature method, comprising: using a first signature key that is a signature key assigned to a user to generate, as first signature data, signature data of an input image; using a second signature key that is a signature key assigned to the signature apparatus to generate, as second signature data, signature data of data that includes the input image and the first signature data; and outputting coupled data that includes the first signature data, the second signature data, and the input image.

According to the fourth aspect of the present invention, there is provided a verification method, comprising: acquiring first signature data of an input image generated by using a signature key assigned to a user, and second signature data of data that includes the input image and the first signature data and is generated by using a signature key assigned to a signature apparatus; and determining success or failure of authentication of a user of the signature apparatus in accordance with a signature source corresponding to the second signature data and a signature source corresponding to the first signature data.

According to the fifth aspect of the present invention, there is provided a non-transitory computer-readable storage medium storing a computer program for causing a computer of a signature apparatus to function as a first generation unit configured to use a first signature key that is a signature key assigned to a user to generate, as first signature data, signature data of an input image; a second generation unit configured to use a second signature key that is a signature key assigned to the signature apparatus to generate, as second signature data, signature data of data that includes the input image and the first signature data; and an output unit configured to output coupled data that includes the first signature data, the second signature data, and the input image.

According to the sixth aspect of the present invention, there is provided a non-transitory computer-readable storage medium storing a computer program for causing a computer of a verification apparatus to function as an acquisition unit configured to acquire first signature data of an input image generated by using a signature key assigned to a user, and second signature data of data that includes the input image and the first signature data and is generated by using a signature key assigned to a signature apparatus; and a determination unit configured to determine success or failure of authentication of a user of the signature apparatus in accordance with a signature source corresponding to the second signature data and a signature source corresponding to the first signature data.

Further features of the present invention will become apparent from the following description of exemplary embodiments (with reference to the attached drawings).

### BRIEF DESCRIPTION OF THE DRAWINGS

FIGS. 1A and 1B are block diagrams that respectively illustrate an example of a hardware configuration of a verification apparatus and a signature apparatus.

FIGS. 2A and 2B are views that respectively illustrate an example of a functional configuration of an image capturing device 115 and an example of a configuration of coupled data.

FIG. 3 is a flowchart illustrating operation of a signature apparatus.

FIG. 4 is a flowchart illustrating detail of processing in step S32.

FIG. 5 is a block diagram illustrating an example of a functional configuration in a PC 11.

FIGS. 6A and 6B are respectively a flowchart illustrating operation of the PC 11 and a view illustrating an example of displaying screens.

FIGS. 7A and 7B are respectively a flowchart illustrating detail of processing in step S62 and a view for illustrating a public key certificate 710.

FIGS. 8A to 8C are respectively a flowchart illustrating detail of processing in step S62, a view illustrating the example of a configuration of coupled data, and a view illustrating an example of displaying a screen.

DESCRIPTION OF THE EMBODIMENTS

Below, explanation will be given for embodiments of the present invention with reference to the accompanying drawings. Note that embodiments described below merely illustrate examples of cases of specifically implementing the present invention, and are only specific embodiments of a configuration defined in the scope of the claims.

### First Embodiment

In the present embodiment, explanation is given regarding each of a signature apparatus that generates signature data for an input image and outputs the input image along with the signature data, and a verification apparatus that verifies the signature data and authenticates a user of the signature apparatus.

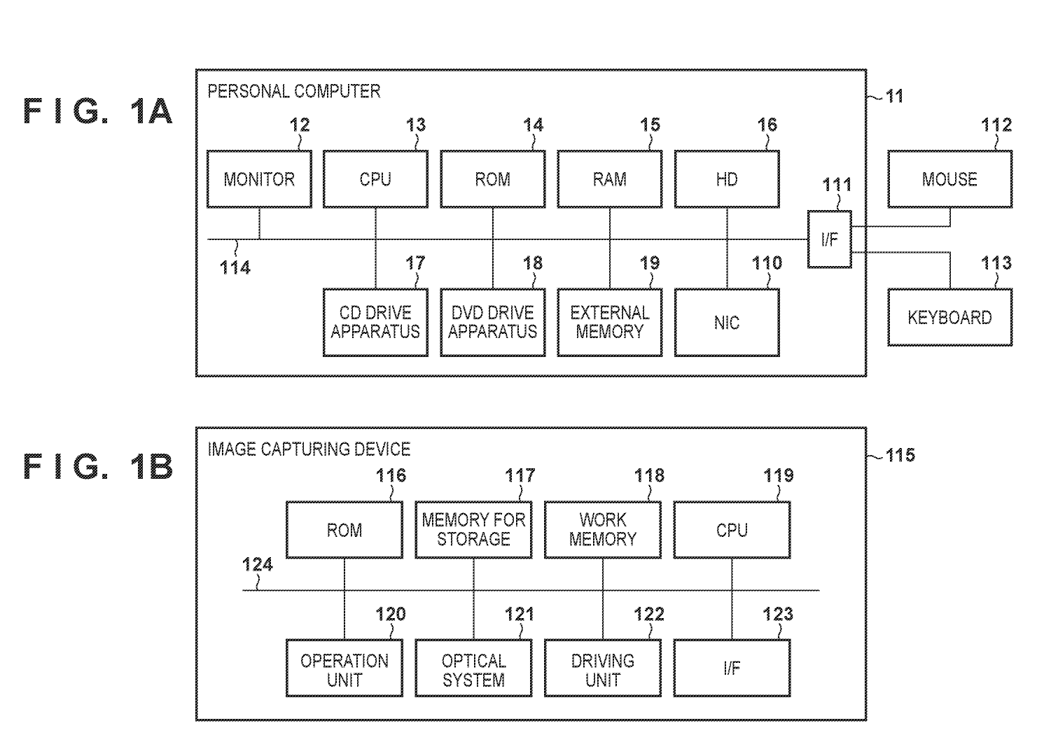

First, an example of a hardware configuration of a verification apparatus according to the present embodiment is explained using the block diagram of FIG. 1A. In the present embodiment, a PC (personal computer) 11 is applied as the verification apparatus, but any apparatus may be applied as the verification apparatus if it is an apparatus that can execute all of the processing described later as something that the verification apparatus performs. For example, a smart phone, a tablet terminal device, or an image processing apparatus that can for example execute copying, scanning, or printing of an image may be applied to the verification apparatus.

A CPU 13 executes processing by using data and a computer program stored in a ROM 14 or a RAM 15. By this, the CPU 13 performs operation control of the PC 11 overall, and also executes or controls all processing described later as something that the PC 11 performs.

The ROM 14 stores setting data and a boot program of the PC 11 that need not be rewritten.

The RAM 15 has an area for storing data or computer programs loaded from the ROM 14, an HD (hard disk) 16, a CD drive apparatus 17, a DVD drive apparatus 18, or an external memory 19. Furthermore, the RAM 15 has an area for storing data or computer programs received from an external unit via an NIC (network interface card) 110. In addition, the RAM 15 has a work area that is used when the CPU 13 executes or controls various processing. In this way, the RAM 15 can appropriately provide various areas.

The HD 16 stores an OS (operating system) and computer programs or data for causing the CPU 13 to execute or control processing described later as something that the PC 11 performs. A computer program or data saved in the HD 16 is appropriately loaded to the RAM 15 in accordance with control by the CPU 13, and becomes a processing target by the CPU 13.

The CD drive apparatus 17 is a device that reads data or a computer program stored in a CD-ROM (CD-R) and outputs it to the RAM 15 or the HD 16. The DVD drive apparatus 18 is a device that reads data or a computer program stored in a DVD-ROM (DVD-RAM) and outputs it to the RAM 15 or the HD 16. Note that a CD-ROM or a DVD-ROM is merely an example of a storage medium for storing data or a computer program, and other kinds of storage mediums may be applied. In such a case, there is a need to provide a corresponding drive apparatus in the PC 11. The external memory 19 is an external memory such as a USB memory.

The NIC 110 is something for performing data communication with an external device wirelessly or by wire, and for example the NIC 110 can perform data communication with a signature apparatus that is described later.

A monitor 12 can display a processing result by the CPU 13 in accordance with an image, text, or the like. A mouse 112 and a keyboard 113 are connected to an I/F (interface) 111.

The mouse 112 and the keyboard 113 are examples of user interfaces for a user to perform various operation inputs. Note that configuration may be taken to cause a user interface such as the mouse 112 and the keyboard 113 to be integrated with the monitor 12 in a touch panel screen.

All of the monitor 12, the CPU 13, the ROM 14, the RAM 15, the HD 16, the I/F 111, the CD drive apparatus 17, the DVD drive apparatus 18, the external memory 19, and the NIC 110 are connected to a bus 114.

Next, an example of a hardware configuration of a signature apparatus according to the present embodiment is explained using the block diagram of FIG. 1B. In the present embodiment, an image capturing device 115 that can capture a still image or a moving image is applied as a signature apparatus, but any apparatus may be applied as the signature apparatus if it is an apparatus that can execute all processing described later as something that the signature apparatus performs. For example, a scanner apparatus or a multi function peripheral may be applied as the signature apparatus.

A ROM 116 stores a computer program and data for causing a CPU 119 to execute or control all processing described later as something that the image capturing device 115 performs.

A memory for storage 117 is a memory for temporarily storing for example a captured image acquired in accordance with an optical system 121 described later. A work memory 118 is a memory for storing data that is a processing target for the CPU 119. For example, in a case of performing various processing on a captured image temporarily stored in the memory for storage 117, the processing is performed after the captured image is copied from the memory for storage 117 to the work memory 118. Note that, regarding a number of memories or a purpose of use of each memory, there is no limitation to the foregoing explanation, and various variations may be considered.

The CPU 119 executes processing by using data and a computer program stored in the ROM 116 or the work memory 118. By this, the CPU 119 performs operation control of the image capturing device 115 overall, and also executes or controls all processing described later as something that the image capturing device 115 performs.

An operation unit 120 is a user interface such as a power button or a shutter button for the input of an image capturing instruction. The optical system 121 includes an optical sensor such as a charge-coupled device CCD or complementary metal oxide semiconductor CMOS, and generates a captured image by converting light of the external world into an electrical signal, and performing various signal processing and image processing with respect to the electrical signal. A driving unit 122 performs various mechanical operations for capturing, such as drive control of the optical system 121, under control by the CPU 119.

For example if a user operates the operation unit 120 to input an image capturing instruction, under control by the CPU 119 the driving unit 122 performs operation control of the optical system 121 so as to be in-focus with the subject, and the optical system 121 generates a captured image that includes the subject and outputs it to the memory for storage 117. The CPU 119 copies the captured image stored in the memory for storage 117 to the work memory 118, and performs compression encoding processing with respect to the copied captured image to generate a compression-encoded image. The CPU 119, by performing signature processing that is described later, then generates and outputs coupled data that includes signature data, a certificate, and the captured image.

An I/F 123 is an interface for connecting a memory apparatus such as a memory card to the image capturing device 115, and is configured by various interfaces such as interfaces for performing data communication with an external device by wire or wirelessly.

All of the ROM 116, the memory for storage 117, the work memory 118, the CPU 119, the operation unit 120, the optical system 121, the driving unit 122, and the I/F 123 are connected to a bus 124.

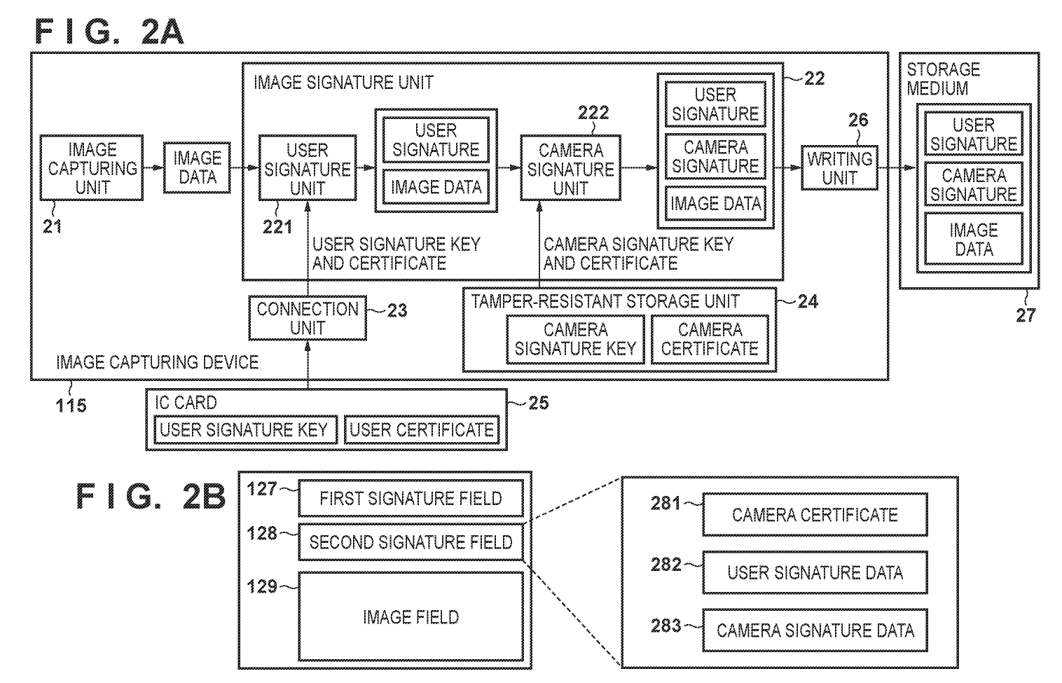

Next, the block diagram of FIG. 2A is used to give an explanation regarding an example of a functional configuration of the image capturing device 115. FIG. 2A illustrates a configuration for a series of processes for generating and outputting coupled data based on a captured image.

A captured image (image data) is acquired by an image capturing unit 21 that includes the above-described optical system 121 and driving unit 122. An image signature unit 22 generates signature data of the captured image acquired by the image capturing unit 21, and outputs the above-described coupled data that includes the captured image, the signature data, and a certificate. A writing unit 26 writes the coupled data to a storage medium 27 such as a memory card that is connected to the I/F 123. The image signature unit 22 (includes a user signature unit 221 and a camera signature unit 222) or the writing unit 26 may be realized by dedicated hardware, or may be realized by a computer program. In the present embodiment, explanation is given regarding a case in which the image signature unit 22 and the writing unit 26 are implemented by a computer program. Note that, although explanation is given below with the image signature unit 22 (it is similar for the user signature unit 221 and the camera signature unit 222) or the writing unit 26 as the agent of processing, in fact a function of a corresponding functional unit is caused to be realized by the CPU 119 executing a corresponding computer program.

The user signature unit 221 reads a user signature key, which is a signature key assigned to a user of the image capturing device 115, and a user certificate, which is a certificate that corresponds to the user signature key, from an IC card 25 that is attachably/detatchably connected to a connection unit 23 as the I/F 123. In other words, by changing the IC card 25 that is caused to connect to the connection unit 23, the user signature unit 221 can acquire the user signature key and user certificate for any user. For the IC card 25, any device such as a storage medium or smart card that has computational capabilities for example may be used.

The user signature unit 221 uses the user signature key to generate, as the user signature data, signature data of the captured image from the image capturing unit 21. In the present embodiment, a signature algorithm for generating the signature data is not limited to a specific algorithm, and various signature algorithms such as RSA or DSA can be applied. For example, configuration may be taken to calculate a hash value of a captured image, and use the hash value and a user signature key to generate user signature data. In addition, regarding a hash function for generating a hash value, there is no limitation to a specific hash function, and various hash functions such as SHA-1 or SHA-256 may be applied. The user signature unit 221 outputs coupled data that includes the captured image, the user signature data, and the user certificate to the camera signature unit 222 that is a subsequent stage. Illustration of a user certificate is omitted from FIG. 2A.

The camera signature unit 222 reads a camera signature key, which is a signature key assigned to the image capturing device 115, and a camera certificate, which is a certificate corresponding to the camera signature key, from a tamper-resistant storage unit 24. The tamper-resistant storage unit 24 uses a mechanism that is physically secure to outside attacks, such as TPM (Trusted Platform Module) (not shown) for example (uses a memory with tamper resistance).

The camera signature unit 222 uses the camera signature key to generate, as camera signature data, signature data for remaining data after omitting the user certificate from the coupled data received from the user signature unit 221, in other words data comprising the captured image and the user signature data. A method of generating the signature data is as described above.

Assuming that a camera signature key is unique information for each image capturing device, the camera signature key in the tamper-resistant storage unit 24 is guaranteed to only be present in the image capturing device 115. Consequently, by including the user signature data as a target for signing by the camera signature key, it is possible to prove that the user signature is executed in the image capturing device 115. In the present embodiment, by treating the owner of the user signature key as the photographer, it is possible to generate a signature that enables photographer authentication.

Note that the camera signature key may be a different camera signature key for each image capturing device, or it may be a camera signature key that is unique for each group resulting from grouping by image capturing device model, export destination, serial number, or the like.

The camera signature unit 222 updates the coupled data by additionally registering the user signature data, the camera signature data, and the camera certificate in the coupled data received from the user signature unit 221, and outputs the updated coupled data to the writing unit 26.

Here FIG. 2B is used to give an explanation regarding an example of a configuration of the coupled data. The coupled data has a first signature field 127, a second signature field 128, and an image field 129, and the user signature unit 221 stores the user signature data and the user certificate to the first signature field 127, and stores the captured image to the image field 129. At this point in time, nothing is stored in the second signature field 128. The camera signature unit 222 then stores a camera certificate 281, user signature data 282, and camera signature data 283 to the second signature field 128.

The writing unit 26 stores the coupled data updated by the camera signature unit 222 to the storage medium 27. Note that, regarding an output destination of the coupled data, it is not limited to the storage medium 27, and various output destinations may be considered. For example, configuration may be taken to transmit it to an external apparatus by wire or wirelessly, or transmit it to the verification apparatus.

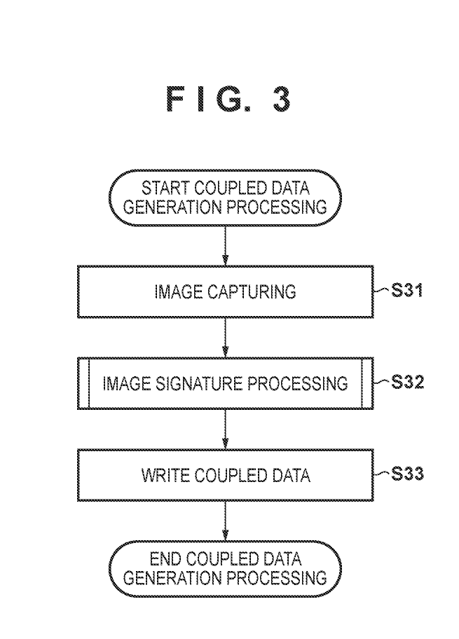

Next, explanation in accordance with the flowchart of FIG. 3 is given regarding operation of the aforementioned signature apparatus. Note that, because details of the processing in each step of FIG. 3 is as described above, a simple explanation is given here.

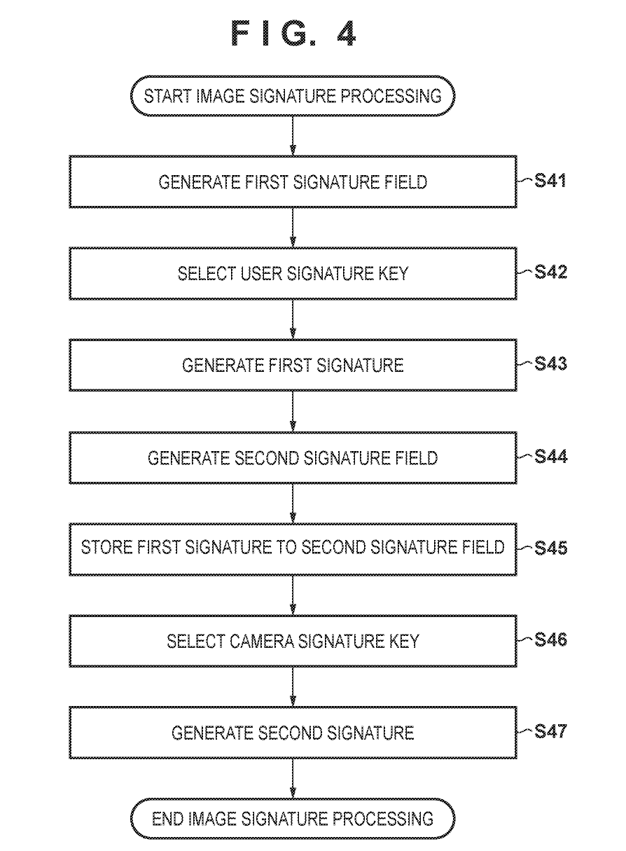

In step S31, a captured image in accordance with the image capturing unit 21 is acquired. Regarding the format of the captured image, it is not limited to a specific format, and various formats such as JPEG, TIFF or RAW can be applied. In step S32, the image signature unit 22 performs signature processing with respect to the captured image acquired in step S31 to generate coupled data. Regarding details of the processing of step S32, it is explained later using FIG. 4. In step S33, the writing unit 26 outputs the coupled data generated in step S32 to an appropriate output destination such as the storage medium 27.

Next, explanation in accordance with the flowchart of FIG. 4 is given regarding detail of the processing in the aforementioned step S32. In step S41, the user signature unit 221 generates the first signature field in the coupled data. In step S42, the user signature unit 221 reads the user signature key from the IC card 25. In step S43, the user signature unit 221 uses the user signature key read in step S42 and generates, as the user signature data, signature data of the captured image acquired in step S31. The user signature unit 221 stores in the first signature field the user signature data together with the user certificate read from the IC card 25. In addition, the user signature unit 221 stores the captured image acquired in step S31 to the image field.

In step S44, the camera signature unit 222 generates the second signature field in the coupled data. In step S45, the camera signature unit 222 stores the user signature data in the second signature field. In step S46, the camera signature unit 222 reads the camera signature key from the tamper-resistant storage unit 24. In step S47, the camera signature unit 222 uses the camera signature key to generate the camera signature data, and stores the generated camera signature data and the camera certificate read from the tamper-resistant storage unit 24 in the second signature field.

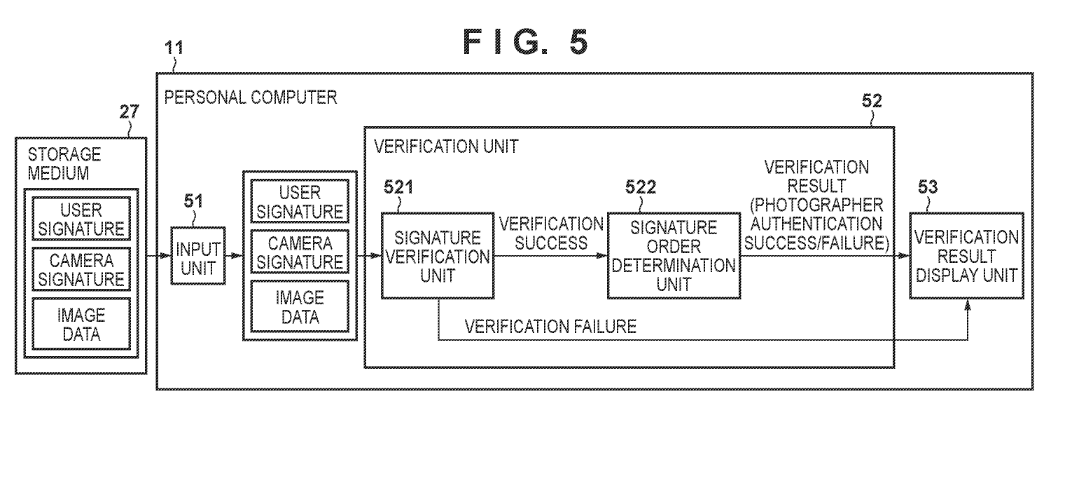

Next, the block diagram of FIG. 5 is used to give an explanation regarding an example of a functional configuration of the PC 11. FIG. 5 illustrates a configuration in accordance with processing for photographer authentication based on the coupled data. An input unit 51 acquires the aforementioned coupled data that is read from the storage medium 27 in accordance with the CD drive apparatus 17 or the DVD drive apparatus 18. Note that the storage medium 27 may be the aforementioned external memory 19. In addition, regarding a method of acquiring the coupled data by the PC 11, there is no limitation to a method of acquiring that goes via the storage medium 27.

A verification unit 52 performs verification processing based on the coupled data acquired by the input unit 51, and also determines a signature order at a time of verification success, and a verification result display unit 53 causes a verification result in accordance with the verification unit 52 to be displayed on the monitor 12.

Note that the input unit 51, the verification unit 52 (includes a signature verification unit 521 and a signature order determination unit 522), and the verification result display unit 53 may be implemented by dedicated hardware, or may be implemented by a computer program. In the present embodiment, explanation is given regarding a case in which these functional units are implemented by a computer program. In addition, these functional units are described as agents of processing below, but actually a function of a corresponding functional unit is realized by the CPU 13 executing a corresponding computer program.

The signature verification unit 521 verifies the signature data in each field in an order of the second signature field and then the first signature field. In the case of the second signature field, verification of the camera signature data 283 is performed by using the captured image in the image field 129, the camera certificate 281, and the user signature data 282. Regarding validity of the camera certificate 281, it is assumed that verification is performed in advance by using a public key of a root certificate authority (not shown). For the public key of the root certificate authority, a public key certificate of a trusted root certificate authority is stored in advance in the HD 16, for example, and a public key included in the public key certificate of the root certificate authority is used. By this, it is possible to verify that the camera certificate 281 was issued from a trusted root certificate authority. In addition, configuration may also be taken to generate a hash value of the captured image and perform verification by using the generated hash value and the public key. Regarding an algorithm and a hash function for performing signature verification, a verification algorithm corresponding to the signature algorithm used in the image signature unit 22 previously described is applied. Accordingly, configuration may be taken to use information that identifies the signature algorithm and the hash function recorded in the signature field to decide an algorithm. In addition, a verification algorithm that has been agreed to by the image capturing device 115 and the PC 11 in advance may be used. When the verification processing with respect to the second signature field completes, next verification processing with respect to the first signature field, in other words verification of the user signature data, is performed. If the verification processing with respect to both of the first signature field and the second signature field succeeded, verification success is set, and if verification processing of either side failed, verification failure is set. Because verification processing of signature data is a well-known technique, an explanation thereof is omitted.

Upon receiving a notification having the gist of verification success from the signature verification unit 521, the signature order determination unit 522 determines the order of the signatures. For example, in the case of the coupled data of FIG. 2B, the signature order determination unit 522 outputs either of photographer authentication success/photographer authentication impossible as a determination result.

The verification result display unit 53 displays on the monitor 12 as the verification result either of verification failure or verification success (and in the case of verification success, either of photographer authentication success/photographer authentication impossible).

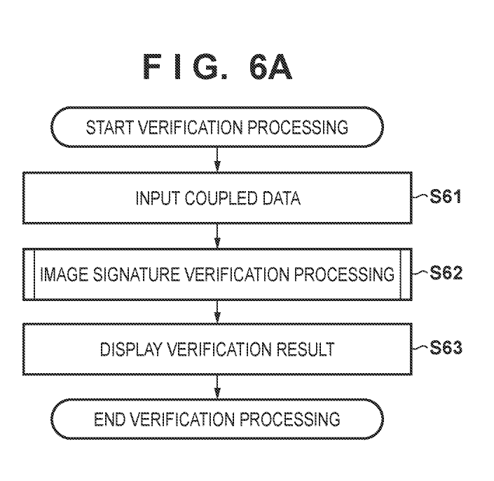

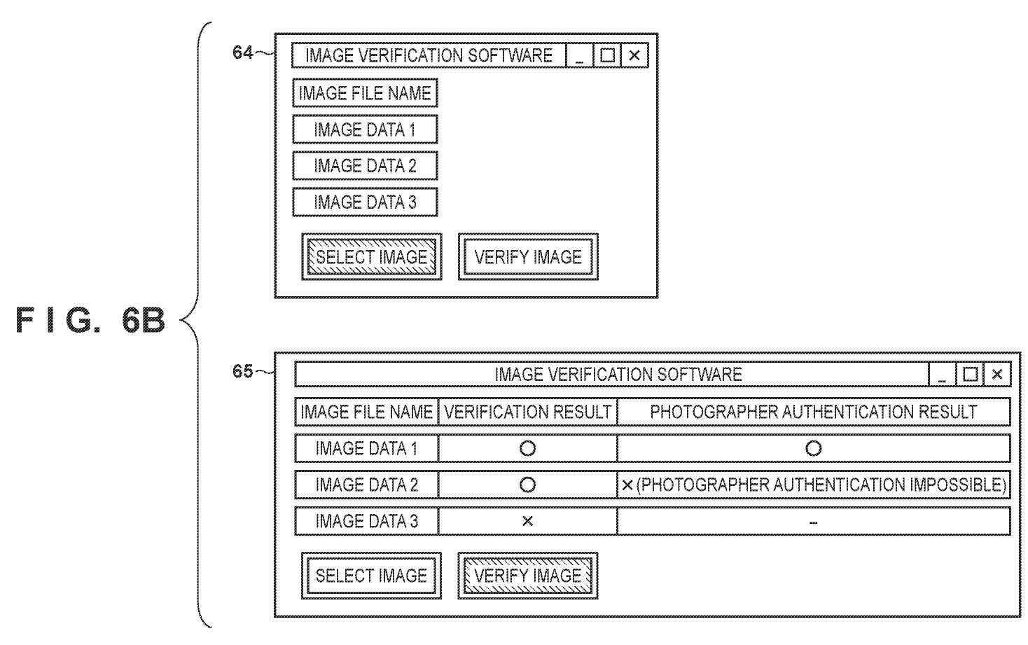

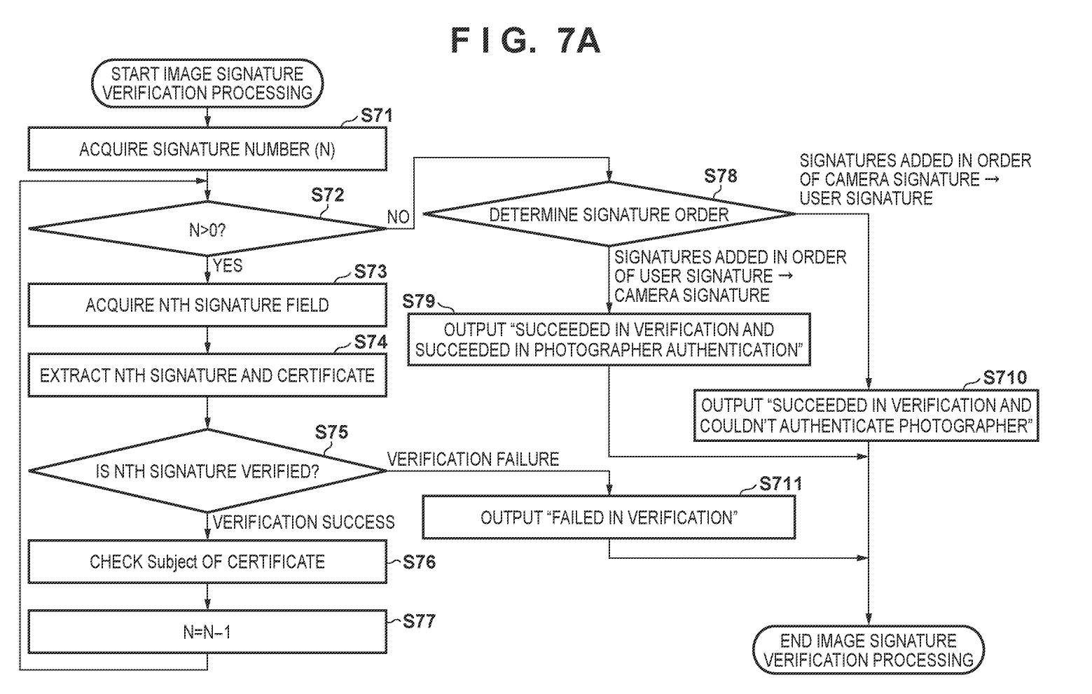

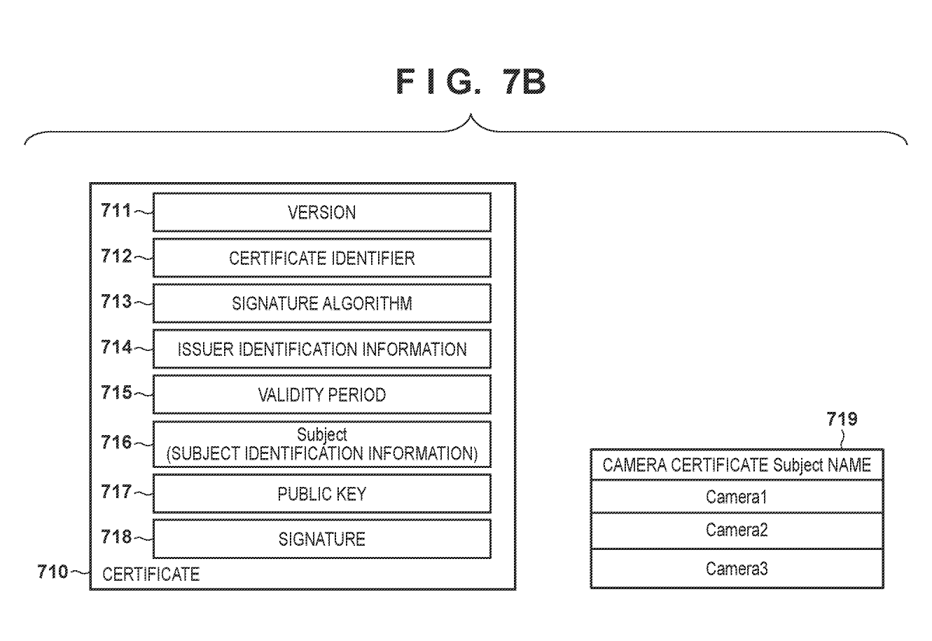

Next, explanation in accordance with the flowchart of FIG. 6A is given regarding operation of the PC 11. In step S61, the input unit 51 acquires the coupled data from the storage medium 27 or the like. In step S62, the signature verification unit 521 uses the coupled data to perform verification processing, and the signature order determination unit 522 determines the order of signatures. Regarding details of the processing of step S62, it is explained later using FIG. 7A. Next, in step S63, the verification result display unit 53 causes the result in step S62 to be displayed on the monitor 12.

Next, explanation in accordance with the flowchart of FIG. 7A is given regarding detail of the processing in the aforementioned step S62. In step S71, the signature verification unit 521 acquires the number of signature fields in the coupled data, and substitutes it in a variable N. In the present embodiment, let N=2. In step S72, the signature verification unit 521 determines whether N>0. As a result of the determination, if N>0 then the processing proceeds to step S73, and if N=0 then the processing proceeds to step S78.

In step S73, the signature verification unit 521 acquires the signature field of the Nth field out of the signature fields provided in an order of the first signature field, the second signature field, . . . from the head of the coupled data—in other words acquires the Nth signature field. In the present embodiment, the first time through step S73 the second signature field is acquired, and in the second time through step S73 the first signature field is acquired.

In step S74, the signature verification unit 521 acquires the signature data and the certificate from the Nth signature field. In the case of the second signature field, the camera certificate, the camera signature data, and the user signature data are acquired, and in the case of the first signature field, the user certificate and the user signature data are acquired.

In step S75, the signature verification unit 521 verifies the signature data acquired in step S74. If the verification succeeded, the processing proceeds to step S76, and if the verification failed the processing proceeds to step 5711.

If verification of the signature data succeeded, it is determined that signature verification processing of the captured image stored in the image field succeeded. Regarding the captured image, it is possible to confirm that it has not been falsified (integrity), that it was signed by a subject that is identified by subject (subject identification information) that is described later (authenticatability), and that Subject cannot repudiate having signed (preventability of repudiation). In the present embodiment, these are together referred to as validity. Meanwhile, if verification of the signature data failed, it is determined that signature verification processing of the captured image failed. In other words, it is not possible to confirm the validity as previously described (integrity, authenticatability, and preventability of repudiation).

In step S76, the signature verification unit 521 executes processing to acquire a subject name of the certificate acquired in step S74. Here, explanation is given in detail regarding a public key certificate in the present embodiment. As illustrated in FIG. 7B, included in the public key certificate 710 is a version 711, a certificate identifier 712, a signature algorithm 713, issuer identification information 714, a validity period 715, a Subject (subject identification information) 716, a public key 717, and a signature 718.

The version 711 is a version of the public key certificate 710. The certificate identifier 712 is an identifier that can uniquely identify the public key certificate 710. The signature algorithm 713 is an identifier of a signature algorithm for generating/verifying the signature 718 which is described later. The issuer identification information 714 is an identifier that can uniquely identify an issuer that issued the public key certificate 710. The validity period 715 is information indicating a start date and an end date and time of the public key certificate 710.

The Subject (subject identification information) 716 is an identifier that can uniquely identify an agent that receives certification, in other words the owner of the public key 717 which is described later. In the present embodiment, because the public key certificate 710 is unique for each image capturing device, the subject is each image capturing device. Note that, if the public key certificate is unique for each group where grouping is done by image capturing device model, export destination, serial number, or the like, or unique for each role, group and user of the image capturing device, these unique things are set as a subject name.

The public key 717 is a public key that is held by the subject of the public key certificate 710. The signature 718 is signature data generated from the version 711, the certificate identifier 712, the signature algorithm 713, the issuer identification information 714, the validity period 715, the Subject (subject identification information) 716, and the public key 717. To generate the signature data, the signature key of the root certificate authority (not shown) is used.

In step S76, the aforementioned Subject (subject identification information) is acquired. Here, regarding a method for determining whether the signature of the signature field is the camera signature in accordance with subject name confirmation processing, explanation is given by using a list of Subject names 719 that indicate being a camera certificate. The list 719 may be stored in advance in the ROM 14 for example, and read out as necessary. In addition, configuration may be taken to connect to the image capturing device 115 at a time of verification, and acquire a Subject from the image capturing device 115. In the determination of step S76, it is determined whether the Subject name of the acquired certificate is included in the list 719. If included then the certificate is determined to be a camera certificate, and if not included then the certificate is determined to be a user certificate.

In step S77, the signature verification unit 521 decrements the value of the variable N by 1. The processing returns to step S72. In step S78, the signature order determination unit 522 determines the signature order. In the case of the coupled data of FIG. 2B for example, because the signature of the second signature field is something in accordance with a camera signature, if the signature of the first signature field is a user signature, photographer authentication success is set. Otherwise, photographer authentication impossible is set. If photographer authentication success is determined, the processing proceeds to step S79, and if photographer authentication impossible is determined, the processing proceeds to step 5710.

In step S79, the signature order determination unit 522 outputs information indicating success for image signature verification and photographer authentication success to the verification result display unit 53. Meanwhile, in in step 5710, the signature order determination unit 522 outputs information indicating success for image signature verification and photographer authentication impossible to the verification result display unit 53. In step S711, the signature verification unit 521 outputs information indicating failure for image signature verification to the verification result display unit 53. The verification result display unit 53 causes a display screen in accordance with the information received from the signature verification unit 521 and the signature order determination unit 522 to be displayed on the monitor 12.

The aforementioned verification processing on the PC 11 can be implemented by application software as follows, for example. The application software is saved in the HD 16, a CD-ROM, a DVD-ROM, or the like. When a user operates the keyboard 113 or the mouse 112 to input an instruction for execution of the application software, the CPU 13 controls the HD 16, the CD drive apparatus 17, the DVD drive apparatus 18, or the like and causes the application software to be loaded into the RAM 15. Upon the CPU 13 executing the application software, a screen 64 on the left side of FIG. 6B is displayed on a display screen of the monitor 12. In the screen 64, out of images stored in a memory such as the HD 16, file names (may be other information such as thumbnail images) of images that a user has operated the keyboard 113 or the mouse 112 to select as images to be verification targets are listed. Furthermore, the screen 64 is provided with an image selection button and an image verification button. When a user operates the keyboard 113 or the mouse 112 to make an instruction on the image selection button, a GUI (not shown) for selecting an image to be a verification target is displayed on a display screen of the monitor 12, and a user can select an image to be a verification target on this GUI. The number of images to select may be one or may be a plurality. When a user, after operating the keyboard 113 or the mouse 112 to perform image selection, inputs an instruction for causing the image selection to end, this GUI is deleted from the screen, and a file name of an image that was selecting using this GUI is displayed as added to the screen 64. When a user operates the keyboard 113 or the mouse 112 to make an instruction on the image verification button on the screen 64, the PC 11 starts verification processing that follows the flowcharts illustrated by FIG. 6A and FIG. 7A.

When the verification processing that follows the flowchart illustrated by FIG. 6A and FIG. 7A completes, a screen 65 on the right side of FIG. 6B is displayed on a display screen of the monitor 12. In the screen 65, a corresponding verification result and photographer authentication result are displayed with respect to each image file name that was listed by the screen 64. As the “verification result”, “∘” is displayed when the verification succeeded, and “×” is displayed when the verification failed. In addition, as a “photographer authentication result”, “∘” is displayed when photographer authentication success is determined, and “×” is displayed when photographer authentication impossible is determined. “-” indicates that a determination for photographer authentication was not performed.

In this way, by virtue of the present embodiment, by determining an order of signatures of signature fields, it is possible to perform photographer authentication. In addition, even if there is a plurality of photographers, it is possible to perform photographer authentication and add a signature in accordance with the IC card 25 that corresponds to a photographer.

### Second Embodiment

In the first embodiment, photographer authentication was performed for a signature that was performed in the image capturing device 115. In the present embodiment, photographer authentication is possible even if an additional signature is performed by the PC 11 after a signature by the image capturing device 115. In each of the following embodiments, including the present embodiment, differences with the first embodiment are predominantly explained, being similar to the first embodiment is assumed to the extent that no mention in particular is given below.

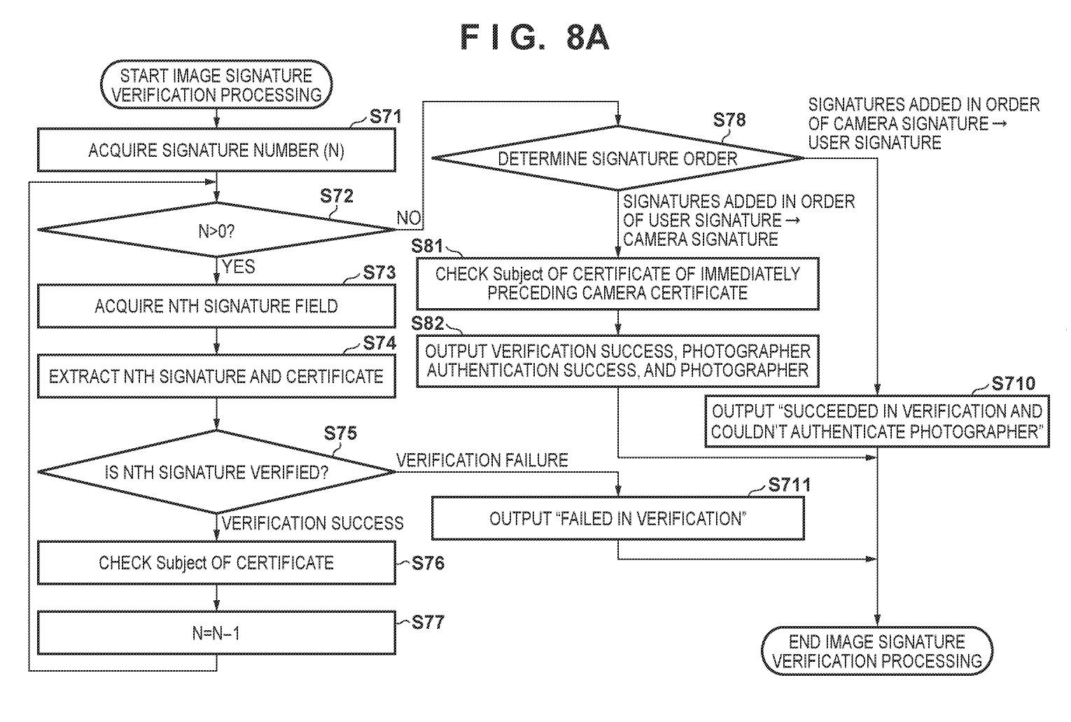

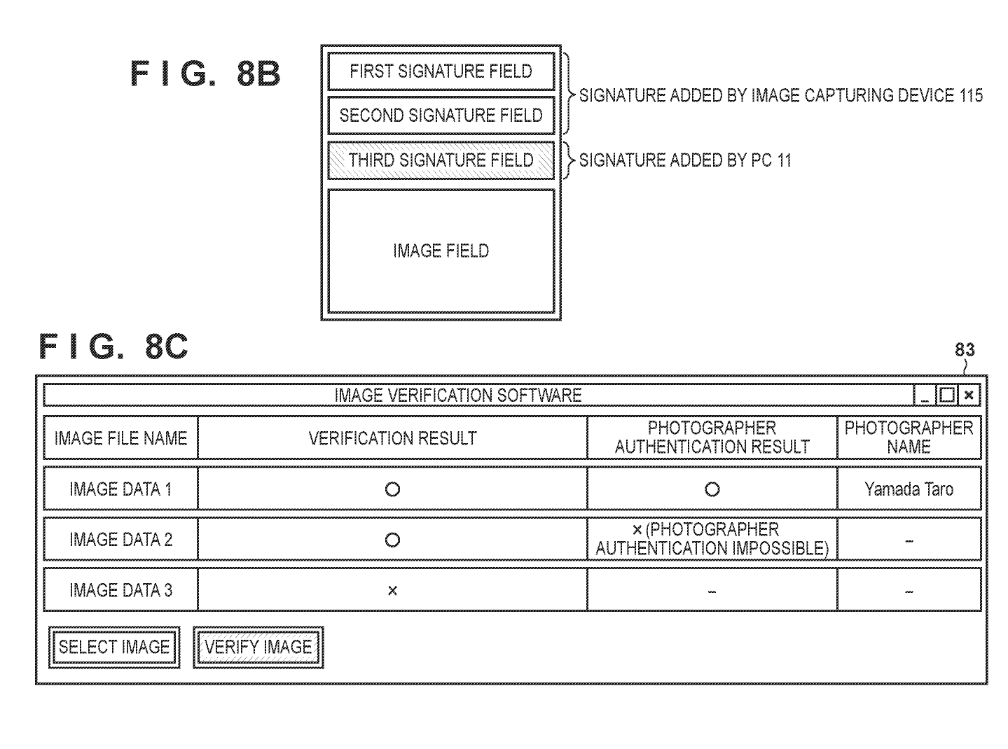

Below, as an example, explanation is given regarding a case in which the PC 11 newly performs a signature in relation to an image that is stored in an image field in coupled data that has the configuration illustrated in FIG. 2B, and the signature data thereof and a corresponding certificate are stored in a third signature field (FIG. 8B). Of course, a method of obtaining the signature data that is stored in the third signature field is not limited to a specific method of obtaining.

In the present embodiment, processing that follows the flowchart illustrated in FIG. 8A is executed in the aforementioned step S62. In FIG. 8A, the same step number is added to the processing steps that are the same as the processing steps illustrated in FIG. 7A, and because the explanation thereof is as described above, explanation for these processing steps is omitted below.

In the case of the flowchart of FIG. 8A, if photographer authentication success is determined in step S78, the processing proceeds to step S81, and if photographer authentication impossible is determined, the processing proceeds to step 5710.

In step S81, the signature verification unit 521 confirms the Subject of the certificate stored in the signature field immediately preceding the second signature field, in other words the first signature field. In step S82, the signature verification unit 521 outputs to the verification result display unit 53 information of the photographer identified by the confirmation of step S81, in addition to information indicating success for image signature verification and photographer authentication success.

The aforementioned verification processing on the PC 11 can be implemented by application software as follows, for example. The application software is saved in the HD 16, a CD-ROM, a DVD-ROM, or the like. When a user operates the keyboard 113 or the mouse 112 to input an instruction for execution of the application software, the CPU 13 controls the HD 16, the CD drive apparatus 17, the DVD drive apparatus 18, or the like and causes the application software to be loaded into the RAM 15. Upon the CPU 13 executing the application software, the screen 64 on the left side of FIG. 6B is displayed on a display screen of the monitor 12. When a user operates the keyboard 113 or the mouse 112 to instruct the image verification button on the screen 64, the PC 11 starts verification processing that follows the flowcharts illustrated by FIG. 6A and FIG. 8A.

When the verification processing that follows the flowchart illustrated by FIG. 6A and FIG. 8A completes, a screen 83 of FIG. 8C is displayed on a display screen of the monitor 12. In the screen 83, a photographer name is displayed in addition to a corresponding verification result and photographer authentication result with respect to each image file name that was listed by the screen 64. Regarding a captured image for which photographer authentication success is determined, the Subject of the certificate confirmed in step S81 is displayed as the photographer. “-” indicates that confirmation for the photographer name was not performed.

### Third Embodiment

In the first and second embodiments explanation was given regarding examples of cases in which a plurality of signatures have been added to coupled data, and a camera signature is always included therein. Explanation is given below regarding an example in which only one signature is included in coupled data. In addition, explanation is given regarding an example in which a camera signature is not included.

When there is only one signature, photographer authentication that was explained above is not possible. In other words, it becomes photographer authentication impossible. Accordingly, from the verification processing explained in the first embodiment, it is possible to simplify the verification processing by omitting step S78 and performing only image signature verification processing.

If a camera signature is not included in coupled data, photographer authentication explained above is not possible. In other words, it becomes photographer authentication impossible. Accordingly, out of the image signature verification processing explained in the first embodiment, in the confirmation of Subject of the certificate of step S76, if only one camera certificate is included, it is possible to omit step S78 to simplify the verification processing.

### Fourth Embodiment

In the first embodiment, in each signature field a certificate corresponding to signature data stored in the signature field is stored, and thus management is possible by associating the signature data and the certificate in the same signature field. However, if it is not possible to manage signature data and a corresponding certificate in association, a method of managing certificates is not limited to the aforementioned method of managing. For example, configuration may be taken to provide a certificate field in coupled data, and store a certificate in association with corresponding signature data therein. In addition, configuration may be taken to create a file that is different from the coupled data, and store a certificate in association with corresponding signature data therein.

Note that, the signature apparatus explained above is something explained as an example of a signature apparatus having a configuration as follows. In other words, using a first signature key, which is a signature key assigned to a user, to generate, as first signature data, signature data of an input image (first generation). In addition, using a second signature key, which is a signature key assigned to a signature apparatus, to generate, as second signature data, signature data of data that includes the input image and the first signature data (second generation). Outputting coupled data that includes the first signature data, the second signature data, and the input image.

In addition, the verification apparatus explained above is something explained as an example of a verification apparatus having a configuration as follows. In other words, acquiring first signature data of an input image generated by using a signature key assigned to a user, and second signature data of data that includes the input image and the first signature data and is generated by using a signature key assigned to the signature apparatus. Performing determination of success or failure of authentication of a user of the signature apparatus in accordance with a signature source corresponding to the second signature data and a signature source corresponding to the first signature data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-081462, filed Apr. 14, 2016, which is hereby incorporated by reference herein in its entirety.

What is claimed is:

1. A signature apparatus, comprising:
a first generation unit configured to use a first signature key that is a signature key assigned to a user to generate, as first signature data, signature data of an input image;
a second generation unit configured to use a second signature key that is a signature key assigned to the signature apparatus to generate, as second signature data, signature data of data that includes the input image and the first signature data; and
an output unit configured to output coupled data that includes the first signature data, the second signature data, and the input image.

2. The signature apparatus according to claim 1, wherein the first generation unit acquires the first signature key that is stored in a memory that can be attached/detached with respect to the signature apparatus.

3. The signature apparatus according to claim 1, wherein the second generation unit acquires the second signature key that is stored in a memory having tamper resistance.

4. The signature apparatus according to claim 1, wherein the coupled data further includes a certificate corresponding to the first signature key and a certificate corresponding to the second signature key.

5. The signature apparatus according to claim 1, wherein the signature apparatus is an image capturing device that acquires the input image by image capturing.

6. A verification apparatus, comprising:
an acquisition unit configured to acquire first signature data of an input image generated by using a signature key assigned to a user, and second signature data of data that includes the input image and the first signature data and is generated by using a signature key assigned to a signature apparatus; and
a determination unit configured to determine success or failure of authentication of a user of the signature apparatus in accordance with a signature source corresponding to the second signature data and a signature source corresponding to the first signature data.

7. The verification apparatus according to claim 6, wherein the determination unit, if, as a result of performing verification processing in an order of the second signature data and then the first signature data, verification succeeded for both of verification with respect to the second signature data and verification with respect to the first signature data, determines success or failure of authentication of a user of the signature apparatus.

8. The verification apparatus according to claim 7, wherein the determination unit, if the verification of both succeeded, uses a certificate corresponding to the first signature data to identify a signature source corresponding to the first signature data, and uses a certificate corresponding to the second signature data to identify a signature source corresponding to the second signature data.

9. The verification apparatus according to claim 6, wherein
the determination unit
if the signature source corresponding to the second signature data is the signature apparatus and the signature source corresponding to the first signature data is a user of the signature apparatus, determines that authentication of the user of the signature apparatus succeeded.

10. The verification apparatus according to claim 6, wherein
the determination unit
if the signature source corresponding to the second signature data is a user of the signature apparatus and the signature source corresponding to the first signature data is the signature apparatus, determines that authentication of the user of the signature apparatus failed.

11. A signature method, comprising:
using a first signature key that is a signature key assigned to a user to generate, as first signature data, signature data of an input image;
using a second signature key that is a signature key assigned to the signature apparatus to generate, as second signature data, signature data of data that includes the input image and the first signature data; and
outputting coupled data that includes the first signature data, the second signature data, and the input image.

12. A verification method, comprising:
acquiring first signature data of an input image generated by using a signature key assigned to a user, and second signature data of data that includes the input image and the first signature data and is generated by using a signature key assigned to a signature apparatus; and
determining success or failure of authentication of a user of the signature apparatus in accordance with a signature source corresponding to the second signature data and a signature source corresponding to the first signature data.

13. A non-transitory computer-readable storage medium storing a computer program for causing a computer of a signature apparatus to function as
a first generation unit configured to use a first signature key that is a signature key assigned to a user to generate, as first signature data, signature data of an input image;
a second generation unit configured to use a second signature key that is a signature key assigned to the signature apparatus to generate, as second signature data, signature data of data that includes the input image and the first signature data; and
an output unit configured to output coupled data that includes the first signature data, the second signature data, and the input image.

14. A non-transitory computer-readable storage medium storing a computer program for causing a computer of a verification apparatus to function as an acquisition unit configured to acquire first signature data of an input image generated by using a signature key assigned to a user, and second signature data of data that includes the input image and the first signature data and is generated by using a signature key assigned to a signature apparatus; and
a determination unit configured to determine success or failure of authentication of a user of the signature apparatus in accordance with a signature source corresponding to the second signature data and a signature source corresponding to the first signature data.
